(19) United States
(12) Patent Application Publication
(10) Pub. No.: US 2009/0045122 A1
(43) Pub. Date: Feb. 19, 2009

(54) Fine bubble diffuser membrane for water and wastewater treatment

(76) Inventor: Jun-Nan Lin, Taipei County (TW)

Correspondence Address: DANIEL B. SCHEIN, PH.D., ESQ., INC., P. O. BOX 68128, Virginia Beach, VA, 23471, US

(21) Appl. No.: 11/893,884

(22) Filed: Aug. 17, 2007

(51) Int. Cl. B01F 3/04

(52) U.S. Cl. 210/220; 261/122.1

(57) ABSTRACT

The present invention discloses a fine bubble diffuser membrane for wastewater treatment, and the tubular diffuser membrane includes a first breathing elastic material fixing layer, a porous elastic polymer laminated layer and a second breathing elastic material fixing layer, and the three layers are attached sequentially with each other, and a number of uniform or non-uniform of penetrating holes are formed on the three layers before or after the three layers are adhered. The three layers sheet is rolled into a tubular shape, and sewed and fixed at the joint, so as to achieve the functions of a quick manufacture and a high efficiency of use.

### FIELD OF THE INVENTION

The present invention relates to a fine bubble diffuser membrane for water and wastewater treatment, and more particularly to a tubular fine bubble diffuser membrane assembled by sewing and from a sheet membrane.

### BACKGROUND OF THE INVENTION

Referring to FIG. 4 for a fine bubble diffuser membrane for water and wastewater treatment, the diffuser is used extensively in wastewater treatment equipments. In a wastewater treatment plant, an air compressor or blower 2 is used for pumping oxygen-containing gas into a biological aeration tank for the oxidation of the pollutants in the wastewater and cleaning the wastewater. The fine bubble diffuser for wastewater treatment 1 is installed at a front end of the air compressor or blower 2 and fixed by fixing rings 21, 22, so that the compressed air passes through the fine bubble diffuser membrane for wastewater treatment 1 to form tiny air bubbles to greatly increase the contact surface of the gas and the wastewater and improving the oxygen transfer efficiency. However, the fine bubble diffuser membrane for wastewater treatment 1 has been commonly made by the manufacturing methods such as injection molding or extrusion using single material. In other words, rubber or polymer type of material is heated and pulled slowly into a tubular shape then punching with small holes so that the air bubbles can form as shown in FIG. 4 then to be used for the wastewater treatment purpose. However, the uniformity of the diffuser membrane wall thickness is difficult to be controlled by such manufacturing method. In addition, the manufacturing process of punching penetrating holes from the tubular shaped membrane can not provide efficient production rate for increasing the economic benefits. In addition, in order to pursue the softness of the diffuser membrane, the manufacturers have to sacrifice the toughness of the material, and thus the present fine bubble diffuser membranes can be easily cut or cracked during the manufacturing or installation process. In the past, the fine bubble diffuser sleeves for wastewater treatment had been made of cloth such as unwoven cloth or woven fabric, but the fine bubble diffuser sleeve made of single layer cloth provides little or no elasticity, and the size of the air penetration holes on the cloth is not uniform which had resulted in decreased aeration efficiency and the holes got clog easily. There has been some fine bubble diffuser membranes made out of polyurethane sheet and assembled into tubular shape by ultrasonic welding at the overlapped edges. For this type of products, the membrane thickness must be thin in order to establish good sealing performance. But, the thin layer will not provide the sufficient material strength that is strongly required in the application.

### SUMMARY OF THE INVENTION

In view of the foregoing shortcomings of the prior art, the inventor of the present invention based on years of experience to conduct extensive researches and experiments, and finally developed a fine bubble diffuser membrane that features a quick manufacturing efficiency and a good aeration performance for water and wastewater treatment, and the fine bubble diffuser membrane can concurrently take material strength and softness into consideration for its production, so as to overcome the shortcomings of the prior art.

It is a primary objective of the present invention to provide a fine bubble diffuser membrane for wastewater treatment, wherein two breathing elastic material fixing layers are formed respectively on upper and lower surfaces of a porous elastic polymer laminated layer, so that the fine bubble diffuser membrane for wastewater treatment can be made into a layered structure quickly and then sewed into a required tubular shape, so as to achieve the functions of a fast manufacture of the fine bubble diffuser membrane and high efficiency with strong material strength.

To achieve the foregoing objective, the present invention provides a fine bubble diffuser membrane for wastewater treatment, and the fine bubble diffuser membrane comprises: a first breathing elastic material fixing layer (made of elastic woven cloth or unwoven cloth), a porous elastic polymer laminated layer (made of EPDM, PU, rubber, PVC, TPE or Neoprene) and a second breathing elastic material fixing layer (made of elastic woven cloth or unwoven cloth), and the three layers are adhered sequentially with each other, and a number of uniform or non-uniform of penetrating holes are formed before or after the three layers sheet is rolled into a tubular shape, and sewed and fixed at the position of a joint.

The above and other objects, features and advantages of the present invention will become apparent from the following detailed description taken with the accompanying drawing.

### BRIEF DESCRIPTION OF THE DRAWINGS

FIG. 1 is a lateral section view of a layered structure of a fine bubble diffuser membrane for wastewater treatment in accordance with the resent invention;

FIG. 2 is a front view of a layered structure of a fine bubble diffuser membrane sheet for wastewater treatment in accordance with a preferred embodiment of the present invention;

FIG. 3 is a lateral section view of a fine bubble diffuser membrane for wastewater treatment in accordance with a preferred embodiment of the present invention;

FIG. 4 is a schematic view of a completed tubular fine bubble diffuser membrane in accordance with the present invention which is being used for wastewater treatment; and

FIG. 5 is a perspective view of a fine bubble diffuser membrane for wastewater treatment in accordance with a preferred embodiment of the present invention.

### DETAILED DESCRIPTION OF THE PREFERRED EMBODIMENTS

To make it easier for our examiner to understand the objective, innovative features and performance of the present invention, we use preferred embodiments and the accompanying drawings for a detailed description of the present invention.

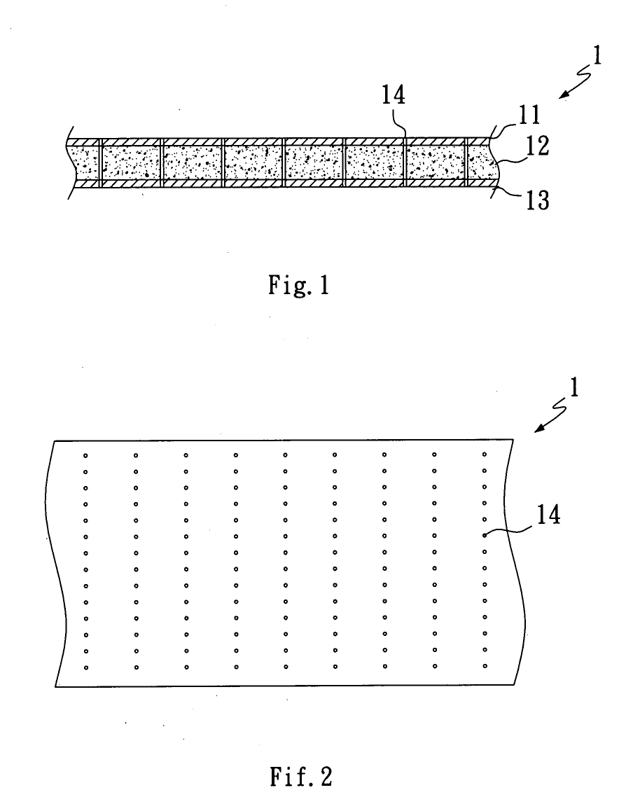

Referring to FIGS. 1 and 2 respectively for a lateral section view and a front view of a layered structure of a fine bubble diffuser membrane for wastewater treatment in accordance with a preferred embodiment of the present invention, the fine bubble diffuser membrane for wastewater treatment comprises a first breathing elastic material fixing layer 11, a porous elastic polymer laminated layer 12 and a second breathing elastic material fixing layer 13 sequentially arranged and adhered with each other by an adhesive, and a number of uniform or non-uniform of penetrating holes 14 formed before or after the three layers are adhered, wherein the first breathing elastic material fixing layer 11 and the second breathing elastic material fixing layer 13 are made of cloth (or any other material suitable for sewing), and the porous elastic polymer laminated layer 12 is made of neoprene, Thermoplastic elastomer (TPE) or polyvinyl chloride (PVC). In FIGS. 1 and 2, the penetrating holes 14 penetrate the first breathing elastic material fixing layer 11, the porous elastic polymer laminated layer 12 and the second breathing elastic material fixing layer 13, and the size and quantity of penetrating holes determine the size and quantity of air bubbles produced in its application.

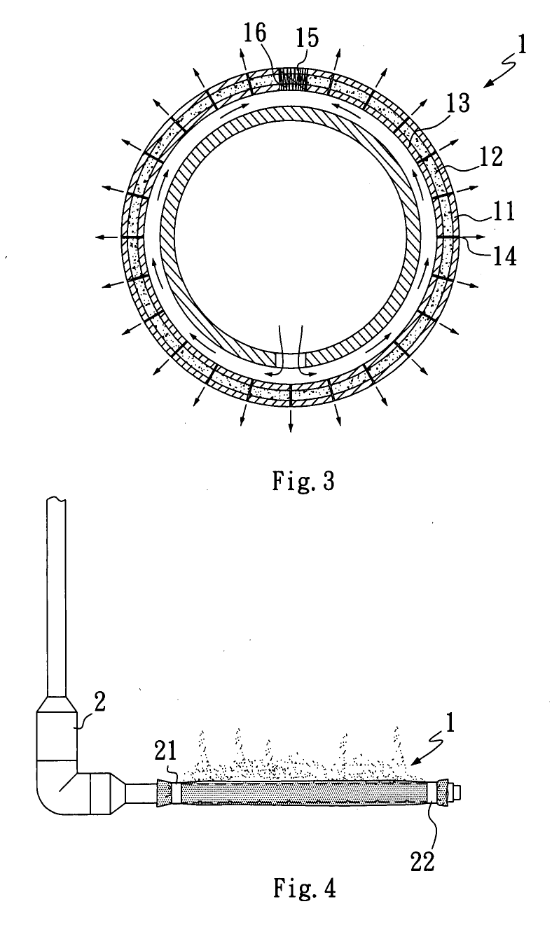

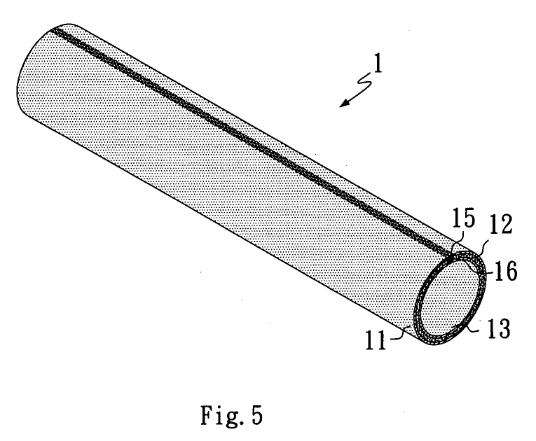

Referring to FIG. 3 for a lateral section view of a fine bubble diffuser membrane for wastewater treatment in accordance with a preferred embodiment of the present invention, and FIG. 5 for a perspective view of a tubular fine bubble diffuser membrane for wastewater treatment in accordance with a preferred embodiment of the present invention, the three-layer structure as shown in FIG. 1 is rolled into a tubular shape, and two fixing ends 15, 16 are cut into a wedge-shape each, and aslant surfaces of the two wedge-shape fixing ends 15, 16 are stacked, or the two fixing ends are cut into a plane (not shown in the figure), and then the two fixing ends are engaged with each other face to face, so that the two fixing ends 15, 16 can be sewed together by vertically up-and-down stitches. Since the first breathing elastic material fixing layer 11 and the second breathing elastic material fixing layer 13 are made of cloth that is suitable for sewing, therefore the first breathing elastic material fixing layer 11 and the second breathing elastic material fixing layer 13 can be fixed securely with each other. Furthermore, an adhesive is applied between the fixing layer and the laminated layer 12, so that an enhanced fine bubble diffuser membrane for wastewater treatment 1 can be accomplished. The structure of the fine bubble diffuser membrane for wastewater treatment 1 is shown in FIG. 5, wherein the layered structure as shown in FIG. 1 can be rolled tightly into a tubular shape by means of the sewing method applied to the first breathing elastic material fixing layer 11 and the second breathing elastic material fixing layer 13, and the finished goods of the fine bubble diffuser membrane as shown in FIG. 4 can be applied for wastewater treatment. The structural design of the invention allows the layered structure to be rolled into a tubular shape, so as to achieve the special effects of a quick manufacture and a convenient way of punching holes.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A fine bubble diffuser membrane for wastewater treatment, comprising:
a first breathing elastic material fixing layer, a porous elastic polymer laminated layer and a second breathing elastic material fixing layer, adhered sequentially with each other to form a three-layer sheet structure; and
a number of uniform or non-uniform of penetrating holes, formed on the three-layer sheet structure before or after the three-layer structure is adhered.

2. The fine bubble diffuser membrane for wastewater treatment as recited in claim 1, wherein the porous elastic polymer laminated layer is made of rubber.

3. The fine bubble diffuser membrane for wastewater treatment as recited in claim 1, wherein the porous elastic polymer laminated layer is made of thermoplastic elastomer (TPE), neoprene or polyvinyl chloride (PVC).

4. The fine bubble diffuser membrane for wastewater treatment as recited in claim 1, wherein the first breathing elastic material fixing layer and the second breathing elastic material fixing layer are made of cloth.

5. A fine bubble diffuser membrane for wastewater treatment, comprising:
a first breathing elastic material fixing layer, a porous elastic polymer laminated layer and a second breathing elastic material fixing layer, attached sequentially with each other to form a three-layer sheet structure; and
a number of uniform or non-uniform of penetrating holes, formed before or after the three-layer structure is adhered;
thereby, the three-layer structure is rolled into a tabular shape for sewing or fixing to a joint.

6. The fine bubble diffuser membrane for wastewater treatment as recited in claim 5, wherein the porous elastic polymer laminated layer is made of rubber.

7. The fine bubble diffuser membrane for wastewater treatment as recited in claim 5, wherein the porous elastic polymer laminated layer is made of neoprene or polyvinyl chloride (PVC).

8. The fine bubble diffuser membrane for wastewater treatment as recited in claim 5, wherein the first breathing elastic material fixing layer and the second breathing elastic material fixing layer are made of cloth.

9. The fine bubble diffuser membrane for wastewater treatment as recited in claim 5, wherein the joint is situated at a position where two connecting ends are cut into a wedge-shape each, and then stacked, sewed and fixed.

10. The fine bubble diffuser membrane for wastewater treatment as recited in claim 5, wherein the joint is situated at a position where two connecting ends are cut into a plane, and then engaged, sewed and fixed with each other face to face.
